(19) United States
(12) Patent Application Publication
(10) Pub. No.: US 2023/0227338 A1
(43) Pub. Date: Jul. 20, 2023

(54) METHOD FOR TREATING A LIQUID SAMPLE COMPRISING A DIAGNOSTIC ASSAY REAGENT AFTER USE

(71) Applicant: Roche Diagnostics Operations, Inc., Indianapolis, IN (US)

(72) Inventors: Kay Hagedorn, Penzberg (DE); Dieter Heindl, Muenchen (DE); Dirk Kessler, Peiting (DE); Hubert Paul, Wielenbach (DE); Martin Rempt, Penzberg (DE); Hans Zahn, Peiting (DE)

(21) Appl. No.: 18/099,412

(22) Filed: Jan. 20, 2023

Related U.S. Application Data
(63) Continuation of application No. PCT/EP2021/069923, filed on Jul. 16, 2021.

(30) Foreign Application Priority Data
Jul. 22, 2020 (EP) 20187160.5

(51) Int. Cl. C02F 1/66; C02F 1/52

(52) U.S. Cl. CPC C02F 1/66; C02F 1/52; C02F 2101/30

(57) ABSTRACT

The present invention relates to a method for treating a liquid sample comprising at least one diagnostic assay reagent after use. The present invention further relates to a tablet, a purified liquid sample, a diagnostic assay reagent, a waste water treatment system, a kit and uses thereof for treating the said liquid sample.

### CROSS-REFERENCE TO RELATED APPLICATIONS

This application is a continuation of International PCT Application No. PCT/EP2021/069923 filed on Jul. 16, 2021, which claims priority to European Patent Application No. 20187160.5 filed on Jul. 22, 2020, the contents of each application are incorporated herein by reference in their entireties.

### FIELD OF THE INVENTION

The present invention relates to a method for treating a liquid sample comprising at least one diagnostic assay reagent after use. The present invention further relates to a tablet, a purified liquid sample, a diagnostic assay reagent, a waste water treatment system, a kit and uses thereof for treating the said liquid sample.

### BACKGROUND OF THE INVENTION

Microplastic, e.g. organic microplastic particles are commonly used in diagnostic tests to create or enhance signals. After completing the test, the liquid sample waste including the microplastic are disposed via the sewage system. This inhibits an environmental and health risk, since little is known about the impacts, hazards and risks surrounding microplastics. Thus, the amount of organic and not biodegradable microplastic needs to be controlled and kept as low as possible. Furthermore, these efforts are driven by legislative pressure on an European level, aiming to restrict the use of microplastics in consumer and professional use products of any kind, including IVDs (in vivo diagnostica).

The mentioned microplastic often comprises particle suspensions (latex beads) in diagnostic tests, which are often composed of negatively charged beads with sizes <500 nm containing in order to make those particles stable in solution. Proteins on the surface can be used for giving the respective disagnostic thest its unique specificity. Due to the small size of the particles, a simple filtration step would not be able to remove those small particles.

As prior art, flocculation substances like inorganic acids, particularly FeCl₃ and AlCl₃, are known to deplete microplastics. However, these inorganic acids lead to the flocculation of the microplastic together with reaction products of these inorganic acids, e.g. as Fe₂O₃ or Al₂O₃. A lot of waste is produced because the flocculation agent is also precipitated with the microplastic. Additionally, the added aluminium that remains in the waste water, pollutes the water and endangers the population with Alzheimer's disease-related aluminum neurotoxicity.

There is thus an urgent need in the art to overcome the above mentioned problems.

It is an object of the present invention to provide a method for treating a liquid sample comprising at least one diagnostic assay reagents after use. Further, it is an object of the present invention to provide a tablet, a purified liquid sample, a diagnostic assay reagent, a waste water treatment system, a kit and uses thereof for treating the said liquid sample.

This object is or these objects are solved by the subject matter of the independent claims. Further embodiments are subjected to the dependent claims.

### SUMMARY OF THE INVENTION

In the following, the present invention relates to the following apects:

In a first aspect, the present invention relates to a method for treating a liquid sample comprising at least one diagnostic assay reagent after use, said method comprises
a) Providing the liquid sample having a pH value, wherein the at least one diagnostic assay reagent is microplastic having at least one pKs value,
b) Treating the liquid sample comprising at least an acid so that the pH value of the liquid sample is smaller than the at least one pKs value of the microplastic, wherein, in particular the changing of the pH value of the liquid sample is induced by the acid itself or a supporting acid,
   wherein the acid is an organic acid or a mineral acid,
   wherein the organic acid is selected from the group consisting of

CH₃−[CH₂]ₙ—COOH with 1<n<4,

COOH—CH₂—(SH)—CH₂—(CH₃)—COOH,

COOH—COOH,

COOH—C(CH)═C(CH)—OH(COOH),

COOH—CF3,

CH₃—[CH₂—CH—COOH]ₘ—CH₃ with m>1,

CH₃—[CH₂—CH—COOH]ₚ—[CH—COOH—CH—COOH]_{q}—CH₃ with p>1 and q>1 and

HO—SO₂—NH₂(CH)ᵣ(CH₂)ₛ—CH₃ with r>1 and s>1.

In a second aspect, the present invention relates to use of the method according to the first aspect of the present invention for separating at least one diagnostic assay reagent after use, in particular microplastic, from a liquid sample, in particular from waste water.

In a third aspect, the present invention relates to a tablet for treating a liquid sample comprising at least one diagnostic assay reagent after use, wherein the tablet comprises

at least an acid, which is capable of reducing the pH value of the liquid sample below the at least one pKs value of the microplastic,
wherein the acid is a powdery solid acid,
wherein the acid is an organic acid or a mineral acid,
wherein the organic acid is selected from the group consisting of

CH₃−[CH₂]ₙ—COOH with 1<n<4,

COOH—CH₂—(SH)—CH₂—(CH₃)—COOH,

COOH—COOH,

COOH—C(CH)═C(CH)—OH(COOH),

COOH—CF3,

CH₃—[CH₂—CH—COOH]ₘ—CH₃ with m>1,

CH₃—[CH₂—CH—COOH]ₚ—[CH—COOH—CH—COOH]_{q}—CH₃ with p>1 and q>1 and

HO—SO₂—NH₂(CH)ᵣ(CH₂)ₛ—CH₃ with r>1 and s>1.

In a fourth aspect, the present invention relates to a purified liquid sample obtainable by the method according to the first aspect of the present invention, wherein the liquid sample is purified waste water, which is cleaned from at least one diagnostic assay reagent after use, wherein in particular the diagnostic assay reagent after use is microplastic.

In a fifth aspect, the present invention relates to a diagnostic assay reagent obtainable by the method according to the first aspect of the present invention, wherein the diagnostic assay reagent is microplastic, which is agglomerated.

In a sixth aspect, the present invention relates to a waste water treatment system for treating a liquid sample comprising at least one diagnostic assay reagent after use, wherein the said system comprises
a vessel, which is capable of collecting the liquid sample having a pH value, wherein at least one diagnostic assay reagent is microplastic having at least one pKs value,
at least one acid, which is capable of adapting the pH value of the liquid sample below the at least one pKs value of the microplastic,
optionally a supporting acid, which is capable of adapting the pH value of the liquid sample below the at least one pKs value of the microplastic,
   wherein the acid is an organic acid or a mineral acid,
   wherein the organic acid is selected from the group consisting of

CH₃−[CH₂]ₙ—COH with 1<n<4,

COOH—CH₂—(SH)—CH₂—(CH₃)—COOH,

COOH—COOH,

COOH—C(CH)═C(CH)—OH(COOH),

COOH—CF3,

CH₃—[CH₂—CH—COOH]ₘ—CH₃ with m>1,

CH₃—[CH₂—CH—COOH]ₚ—[CH—COOH—CH—COOH]_{q}—CH₃ with p>1 and q>1 and

HO—SO₂—NH₂(CH)ᵣ(CH₂)ₛ—CH₃ with r>1 and s>1.

In a seventh aspect, the present invention relates to use of the waste water treatment system of the sixth aspect of the present invention for treating a liquid sample comprising at least one diagnostic assay reagent after use.

In a eighth aspect, the present invention relates to a kit suitable to perform a method of the first aspect of the present invention comprising
a tablet according to the third aspect of the present invention,
a separation unit, which is capable of separating the microplastic and the liquid sample, and
optionally a vessel.

In a ninth aspect, the present invention relates to use of a kit of the eight aspect of the present invention in a method of the first aspect of the present invention.

In a tenth aspect, the present invention relates to an acid for treating a liquid sample comprising at least one diagnostic assay reagent after use,

wherein said acid is an organic acid or a mineral acid,
wherein the organic acid is selected from the group consisting of

CH₃−[CH₂]ₙ—COH with 1<n<4,

COOH—CH₂—(SH)—CH₂—(CH₃)—COOH,

COOH—COOH,

COOH—C(CH)═C(CH)—OH(COOH),

COOH—CF3,

CH₃—[CH₂—CH—COOH]ₘ—CH₃ with m>1,

CH₃—[CH₂—CH—COOH]ₚ—[CH—COOH—CH—COOH]_{q}—CH₃ with p>1 and q>1 and

HO—SO₂—NH₂(CH)ᵣ(CH₂)ₛ—CH₃ with r>1 and s>1, wherein the acid is capable of changing the pH value of the liquid sample over the at least one pKs value of the at least one diagnostic assay reagent after use.

### DESCRIPTION OF THE FIGURES

FIG. 1 shows a waste water treatment system for treating a liquid sample comprising at least one diagnostic assay reagent after use.

### DETAILED DESCRIPTION OF THE INVENTION

Before the present invention is described in detail below, it is to be understood that this invention is not limited to the particular embodiments and examples described herein as these may vary. It is also to be understood that the terminology used herein is for the purpose of describing particular embodiments only, and is not intended to limit the scope of the present invention which will be limited only by the appended claims. Unless defined otherwise, all technical and scientific terms used herein have the same meanings as commonly understood by one of ordinary skill in the art.

Several documents are cited throughout the text of this specification. Each of the documents cited herein (including all patents, patent applications, scientific publications, manufacturer's specifications, instructions etc.), whether supra or infra, is hereby incorporated by reference in its entirety. In the event of a conflict between the definitions or teachings of such incorporated references and definitions or teachings recited in the present specification, the text of the present specification takes precedence.

In the following, the elements of the present invention will be described. These elements are listed with specific embodiments, however, it should be understood that they may be combined in any manner and in any number to create additional embodiments. The various described examples and preferred embodiments should not be construed to limit the present invention to only the explicitly described embodiments. This description should be understood to support and encompass embodiments which combine the explicitly described embodiments with any number of the disclosed and/or preferred elements. Furthermore, any permutations and combinations of all described elements in this application should be considered disclosed by the description of the present application unless the context indicates otherwise.

### Definitions

The word “comprise”, and variations such as “comprises” and “comprising”, will be understood to imply the inclusion of a stated integer or step or group of integers or steps but not the exclusion of any other integer or step or group of integers or steps.

As used in this specification and the appended claims, the singular forms “a”, “an”, and “the” include plural referents, unless the content clearly dictates otherwise.

Percentages, concentrations, amounts, and other numerical data may be expressed or presented herein in a “range” format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “4% to 20%” should be interpreted to include not only the explicitly recited values of 4% to 20%, but to also include individual values and sub-ranges within the indicated range. Thus, included in this numerical range are individual values such as 4, 5, 6, 7, 8, 9, 10, . . . 18, 19, 20% and sub-ranges such as from 4-10%, 5-15%, 10-20%, etc. This same principle applies to ranges reciting minimal or maximal values. Furthermore, such an interpretation should apply regardless of the breadth of the range or the characteristics being described.

The term “about” when used in connection with a numerical value is meant to encompass numerical values within a range having a lower limit that is 5% smaller than the indicated numerical value and having an upper limit that is 5% larger than the indicated numerical value.

The term “treatement” or treating” as used herein refers to the dealing of the liquid sample by a process or a human. A process can be sensor driven, e.g. by pH value of the solution, or time driven, e.g. after x hours after one time tablet addition, or flow driven, e.g. after x ml of liquid. X means in this context a real number, e.g. 1, 1.5, 2 etc.

The term “sample” or “liquid sample” as used herein refers to a sample, which has a liquid aggregation behavior, in particular at room temperature or up to 70° C. The liquid sample is a final product, e.g. of a business process or of an industrial process or of a manufacturing process, which is no longer needed for the business or process or manufacturing and is therefore disposed of. The liquid sample is in particular water based, which means that water is the main component. Main component can mean in this context that the liquid sample comprises at least 90% (v/m or m/m) of water. Waste water is any water that has been contaminated by human use. Waste water may include particulate matter, e.g. as a suspension, wherein the particulate matter may be settleable matter or matter that does not settle or sediment. The liquid sample comprises a diagnostic assay reagent/or processed assay reagent after use. Preferably, the liquid sample is a final product resulting from an IVD (In-vitro-Diagnostic) process.

The term “diagnostic assay reagent after use” or “processed diagnostic assay reagent” as used herein refers to an agent or a reagent, which is/was used in an industrial process or manufacturing process or measuring process. The diagnostic assay reagent after use is no longer used or needed in the process. The diagnostic assay reagent after use can be separated from the liquid sample. Preferably, the diagnostic assay reagent after use is an diagnostic assay reagent of an IVD (In-vitro-Diagnostic) process or a waste product from an IVD process. The purified liquid sample is disposed, for example, in a wastewater treatment plant. “Purified” can mean in this context that the liquid sample is free of the diagnostic assay reagent after use. In particular, diagnostic assay reagent after use refers in this context to a reagent, which is/was used in a diagnostic assay.

The term “pH value” as used herein refers to a scale at 25° C. used to specify how acidic or basic the liquid sample is. At 25° C., the liquid sample with a pH value of less than 7 is acidic. A liquid sample with a pH value of greater than 7 is basic. A liquid sample with a pH value of equal to 7 is neutral. The pH value can be less than 0 for very strong acids, or greater than 14 for very strong bases. The pH value can be determined by a pH meter.

The term “pKs value” as used herein refers to the negative base-10 logarithm of the acid dissociation constant (Ks) of at least one diagnostic assay reagents after use, in particular of the microplastic. The pKs value can be determined by pH-metric methods. The pKs can be measured by titrating a solution of the microplastic sample in water or solvent with acid and base, and calculating the pKs from the shape of the titration curve. The term “at least one pKs value” means in this context that the microplastic can comprise one, two or more than two, e.g. three, pKs values depending on the possible dissociation steps of the microplastic. For example, a mono-protonic microplastic can have one pKs value, a two-protonic microplastic can have two pKs values and a three-protonic microplastic can have three pKs values. This can depend on the possible dissociation of the microplastic. In embodiments of the invention, the microplastic has more than one pKs value, e.g. 2 or 3. In particular, if the microplastic has more than one pKs value, the lowest or smallest pKs value is meant. For example, if the microplastic has two pKs values of 3 and 4, the lowest pKs value of the microplastic is 3.

The term “acid is REACH conform” means in this context that the acid is in compliance with the REACH regulation (EG) 1907/2006.

The term “acid is WGK conform” means in this context that the acid is not hazardous to water in respect to the German water hazard class (regulation on installations for handling substances hazardous to water (AwSV)).

The term “supporting acid” means in this context a chemical species that donates protons or hydrogen ions and/or accepts electrons. The supporting acid is capable of changing, in particular reducing, the pH value of the liquid sample in an acid range (pH <7), in particular below the pKs value of the microplastic.

The term “induced by the acid itself or a supporting acid” means in this context that by treating or adding the acid or the supporting acid to the liquid sample a change of the pH value of the liquid sample results, in particular the pH value of the liquid sample changes below the pKs value of the microplastic.

The term “plastic” can denote synthetic material consisting of, comprising or made from organic polymers. The term “microplastic” as used herein refers to a plastic material, in particular plastic particles, with a diameter of less than 5 mm (5000 microns). More particulary, the microplastic can have a particle size of 1 nm to 5000 nm, e.g. in the range of 100 nm to 300 nm or in the range of 50 nm to 500 nm or a particle size of 2300 nm. In particular, microplastic comprises solid polymer-containing particles, to which additives or other substances may be added, and/or where more than or equal to 1% w/w of the particles have (i) all dimensions 1 nm≤x≤5 mm, or (ii), for fibres, a length of 3 nm≤x≤15 mm and length to diameter ration of more than 3. In particular, the microplastic is protein loaded. Microplastic can form at least one ore more than one particles. The minimum for forming particle agglomerates or particle aggregates is two particles.

The term “particle” means in this context a minute piece of matter with a defined physical bounderies. A a defined physical boundery is an interface.

The term “polymer-containing particle” means (i) a particle of any composition with at least partially continuous or completely continuous polymer surface coating of any thickness and/or (ii) a particle of any composition with a polymer content of more than or equal to 1% w/w. Preferably, the polymer is an organic polymer.

The term “solid” means a substance or a mixture which is not liquid or gaseous.

The term “gas” means a substance which (i) at 50° C. has a vapour pressure greater than 300 kPa (absolute), or (ii) is completely gaseous at 20° C. at a standard pressure of 101.3 kPa.

The term “protein loaded” means in this context that the microplastic comprises, in particular on its surface and or particle pore surface, any of a class of nitrogenous organic compound. The nitrogenous organic compound comprises one or more chains of amino acids. Especially, they are an essential part of all living organisms, especially as structural components of body tissues such as muscle, hair, etc., and as enzymes, polypeptides and antibodies.

The term “agglomeration” means in this context an accociation of at least two microplastic particles in the liquid sample, in particular more than two microplastic particles, e.g. <100. Agglomeration comprises destabilization, coagulation, flocculation and/or precipitation. In one embodiment the terms “agglomeration” and “aggregation” can be used interchangeably. In another embodiment the terms agglomeration and aggregation can be used as disclosed, e.g. by Nichols et al. J. Pharm. Sci, 91, 10, 2002, 2103 to 2109.

The term “latex particles” or “latex” means in this context that the “latex particles” or “latex” form a colloidal dispersion of polymer particles in a liquid. Synthetic latex is latex that is obtained as a product of an emulsion, mini-emulsion, micro-emulsion, or dispersion polymerization. Preferably, the term “latex particles” means in this context that it is formed of styrene or styrene related components by getting polymerized with a repletion unit >100 styrene/styrene related moieties. Latex itself can be a stable dispersion (emulsion) of polymer microparticles in an aqueous medium. It can be found in nature, but synthetic latexes can be made by polymerizing a monomer such as styrene that has been emulsified with surfactants.

The term “click reagent” means in this context that the reagents undergo click chemistry. In chemical synthesis, click chemistry is a class of biocompatible small molecule reactions commonly used in bioconjugation, allowing the joining of substrates of choice with specific biomolecules. Click chemistry is known for a skilled person in the art and can be e.g. azide/alkine, NHS etc. as example chemistries.

A “kit” is any manufacture (e.g., a package or container) comprising at least one reagent, e.g., a medicament for treatment of a disorder, or a probe for specifically detecting a biomarker gene or protein of the invention. The kit is preferably promoted, distributed, or sold as a unit for performing the methods of the present invention. Typically, a kit may further comprise carrier means being compartmentalised to receive in close confinement one or more container means such as vials, tubes, and the like. In particular, each of the container means comprises one of the separate elements to be used in the method of the first aspect. Kits may further comprise one or more other reagents including but not limited to reaction catalyst. Kits may further comprise one or more other containers comprising further materials including but not limited to buffers, diluents, filters, needles, syringes, and package inserts with instructions for use. A tablet may be present on the container to indicate that the composition is used for a specific application, and may also indicate directions for either in vivo or in vitro use. The computer program code may be provided on a data storage medium or device such as a optical storage medium (e.g., a Compact Disc) or directly on a computer or data processing device. Moreover, the kit may, comprise standard amounts for the acid as described elsewhere herein for calibration purposes.

The term “tablet” is a pharmaceutical oral dosage form (Oral Solid Dosage, or OSD) or solid unit dosage form. Tablets may be defined as the solid unit dosage form of medicament or medicaments with suitable excipients. Tablets are prepared either by molding or by compression. It comprises a mixture of active substances and excipients, usually in powder form, pressed or compacted from a powder into a solid dose. The excipients can include diluents, binders or granulating agents, glidants (flow aids) and lubricants to ensure efficient tabletting; disintegrants to promote tablet break-up in the digestive tract; sweeteners or flavours to enhance taste; and pigments to make the tablets visually attractive or aid in visual identification of an unknown tablet. A polymer coating can be applied to make the tablet smoother and easier to swallow, to control the release rate of the active ingredient, to make it more resistant to the environment (extending its shelf life), or to enhance the tablet's appearance. The tablet can be a pill, caplet or orally disintegrating tablet (ODT). The tablet can be manufactured by the tablet pressing process. The appropriate amount of active ingredient has to be in each tablet by well-mixing the ingredients. Wet granulation and/or dry granulation can be used to granulate powders for compression into a tablet. Powders that can be mixed well do not require granulation and can be compressed into tablets through direct compression.

The term “microplastic is agglomerated” in this context means in particular that the microplastic forms particles, wherein these particles form a agglomeration structure.

The term “high concentration clinical waste water” is the combination of the resulting liquid streams which comes out of a clinical analyzer after processing reagents or sample and diluents. Waste water can be further separated within the device to obtain a high concentrated fraction by splitting the diluent precessing steps of the sample processing steps after the measuring unit.

The term “saturation” is the point at which a solution of a substance, e.g. acid, can dissolve no more of that substance. This point of maximum concentration, the saturation point, depends on the temperature of the liquid sample as well as the chemical nature of the substances, e.g. acid, involved.

The term “powdery solid acid” is a granulated solid with particle sizes between 100 nm and 10 mm.

The term “changing pH value” can mean in this context that the pH value, e.g. of the liquid sample is increased compared to the pH value before the changing. Alternatively, the term “changing pH value” can mean in this context that the pH value, e.g. of the liquid sample is decreased compared to the pH value before the changing.

The term “clean” and “purified” can be used interchangeably.

The term “gravitation” is an industrial method of separating two components, either a suspension, or dry granular mixture where separating the components with gravity is sufficiently practical: i.e. the components of the mixture have different specific weight.

The term “filtration” is a physical, biological or chemical operation that separates solid matter and fluid from a mixture with a filter medium that has a complex structure through which only the fluid can pass. Solid particles that cannot pass through the filter medium are described as oversize and the fluid that passes through is called the filtrate.

The term “extraction” in chemistry is a separation process consisting in the separation of a substance from a matrix. Common examples include liquid-liquid extraction, and solid phase extraction. The distribution of a solute between two phases is an equilibrium condition described by partition theory. This is based on exactly how the analyte moves from the initial solvent into the extracting solvent. The term washing may also be used to refer to an extraction in which impurities are extracted from the solvent containing the desired compound.

The term “separation” is a process of dividing two compartments which are combined and divided after the process of separation e.g. by filtration, flocculation or extraction.

### Embodiments

In a first aspect, the present invention relates to a method for treating a liquid sample comprising at least one diagnostic assay reagent after use, said method comprises
a) Providing the liquid sample having a pH value, wherein the at least one diagnostic assay reagent is microplastic having at least one pKs value,
b) Treating the liquid sample comprising at least an acid so that the pH value of the liquid sample is smaller than the pKs value of the microplastic, wherein, in particular, the changing of the pH value of the liquid sample is induced by the acid itself or a supporting acid,
   wherein the acid is an organic acid or a mineral acid,
   wherein the organic acid is selected from the group consisting of

CH₃−[CH₂]ₙ—COH with 1<n<4,

COOH—CH₂—(SH)—CH₂—(CH₃)—COOH,

COOH—COOH,

COOH—C(CH)═C(CH)—OH(COOH),

COOH—CF3,

CH₃—[CH₂—CH—COOH]ₘ—CH₃ with m>1,

CH₃—[CH₂—CH—COOH]ₚ—[CH—COOH—CH—COOH]_{q}—CH₃ with p>1 and q>1 and

HO—SO₂—NH₂(CH)ᵣ(CH₂)ₛ—CH₃ with r>1 and s>1.

According to the method of the first aspect of the invention, the mineral acid can be selected from the group consisting of H₂SO₄, H₂SO₃, HCl, HBr, HI, HF, HClO, HNO₃, HNO₂, H₃PO₄, [Fe(H₂O)_{6]}³⁺ and [Al(H₂O)_{6]}³⁺.

According to the method of the first aspect of the invention, the liquid sample is provide in step (a). The liquid sample has a pH value. The liquid sample comprises at least one or more than one diagnostic assay reagents.

According to the method of the first aspect of the invention, the liquid sample is treated in step (b). The liquid sample comprises at least an acid. The liquid sample is treated so that the pH value of the liquid sample is smaller than the pKs value of the microplastic. In particular, the pH value of the liquid sample is reduced or changed by the acid itself or a supporting acid. The acid is an organic acid or a mineral acid. The organic acid is selected from the group consisting of CH₃—[CH₂]ₙ—COOH with 1<n<4, COOH—CH₂—(SH)—CH₂—(CH₃)—COOH, COOH—COOH, COOH—C(CH)═C(CH)—OH(COOH), COOH—CF₃, CH₃—[CH₂—CH—COOH]ₘ—CH₃ with m>1, CH₃—[CH₂—CH—COOH]ₚ—[CH—COOH—CH—COOH]_{q}—CH₃ with p>1 and q>1 and HO—SO₂—NH₂(CH)ᵣ(CH₂)ₛ—CH₃ with r>1 and s>1. Preferably, the acid is WGK and/or REACH conform.

In embodiments of the first aspect of the present invention, the supporting acid is different from the acid. Preferably, the supporting acid is not an organic acid and/or mineral acid as mentioned in the disclosure. Preferably, the supporting acid is REACH and/or WGK conform.

In embodiments of the first aspect of the present invention, the supporting acid is selected from the following group: maleic acid, amidosulfonic acid, salicylic acid, polyacrylic acid, FeCl₃ and PAA-co-MA. Preferably, the supporting acid is selected from the following group: maleic acid, amidosulfonic acid, salicylic acid, polyacrylic acid and poly(acrylic acid-co-maleic acid (PAA-co-MA).

In embodiments of the first invention, the liquid sample comprises at least one acid. The content of the at least one acid or more than one acids, for example, a mixture of two acids, is at least the concentration value to bring the liquid sample to an pH value smaller than the pKs value of the respective microplastic in the liquid sample.

In embodiments of the first invention, the liquid sample, e.g. a serum, plasma or whole blood sample, is a liquid flow. In particular, the liquid sample is a collected liquid flow. The term “collected liquid flow” can mean in this context that the liquid flow is collected, e.g. in a vessel.

The inventors surprisingly found that the above mentioned acids exhibit a destabilizing effect of the microplastic, in particular negatively charged, protein loaded latex microparticles. The advantages of using said acids, in particular solid (cyrstaline) organic acids having a low pKs instead of concentrated liquid acids or mineral acids, is their easy handling and dosing, lower toxicity and lower hazardous potential. These acids can be provided in a pill/tablet format with exact weight/amount of acid. Therefore some of the organic acids are used and are eligible for cleaning (decalcification) of coffee machines or water boiler with low or no environmental damage potential.

In embodiments of the first aspect of the present invention, the liquid sample has a pH value of 7 or more than 7 in step a).

In embodiments of the first aspect of the present invention, the pH value of the liquid sample is alkaline, for example, more than 11. The pH value of the liquid sample is, for example, 11 or 12 or 13 or 14.

In embodiments of the first aspect of the present invention, the method comprises at least one further step selected from the group consisting of:
c) Agglomeration the microplastic in the liquid sample,
d) Removing the microplatic, in particular the agglomerated microplastic, from the liquid sample,
e) Increasing the pH value of the liquid sample after removing the microplastic, for example, to a pH value of 7 or more,
f) Determining the pKs value of the microplastic,
   or combinations of steps (c) to (f). This can mean that the method comprises the following steps:
(a), (b) and (c) or
(a), (b) and (d) or
(a), (b) and (e) or
(a), (b) and (f) or
(a), (b) and combinations of (c), (d), (e) and (f).

In embodiments of the first aspect of the present invention, step (f) is performed before step (a) and/or step (b). The pKs value of the microplastic can be determined by Dynamic Light Scattering (DLS) or other suitable methods or is a known value, e.g. from literature. If only known types of pKs exhibiting particles through the diagnostic process exist or are present, a predetermined pKs value can be used.

In embodiments of the first aspect of the present invention, the microplastic are nanoparticles having a diameter of smaller than 1 mm, in particular smaller than or equal to 500 nm, 250 nm, 200 nm, 150 nm, 110 nm or 100 nm. Additionally or alternatively, the microplastic are nanoparticles having a diameter of bigger than 40 nm, in particular bigger than or equal to 50 nm or 55 nm or 60 nm or 65 nm or 70 nm.

In embodiments of the first aspect of the present invention, the method comprises a step (c): Agglomeration the microplastic in the liquid sample. Agglomeration is done by protonation supported by the respective acid and further vanishment of the separation aspect done by the negative charged particles. If amino acids used as an auxillary reagent. Therefore also acids e.g. acetic acid, which are not capable to destabilize the microparticles alone can be used as precipitation agent.

In embodiments of the first aspect of the present invention, method comprises a step (d): Removing the microplatic, in particular the agglomerated microplastic, from the liquid sample. The aggregated samples or agglomerated sample comprises an diameter of the whole complex larger than the microplastic alone. If the resulting agglomerates are >500 nm the area of microfiltration can be reached with high efficiency rates. Therefore simple paper and/or sand filters or centrifugation can be used to remove the destabilized/agglomerated microplastic.

In embodiments of the first aspect of the present invention, method comprises a step (e): Increasing the pH value of the liquid sample after removing the microplastic, for example, to a pH value of 7 or more. The pH value can be increased or changed by the addition of the acid or supporting acids, e.g. maleic acid, amidosulfonic acid, salicylic acid, polyacrylic acid, FeCl₃ and/or PAA-co-MA.

In embodiments of the first aspect of the present invention, the microplastic agglomerates in step (c) if the pH value of the liquid sample is smaller than the pKs value of the microplastic.

In embodiments of the first aspect of the present invention, the microplastic does not agglomerate in step (c) if the pH value of the liquid sample is greater than the pKs value of the microplastic. With other words, the microplastic are then stable in step (c).

In embodiments of the first aspect of the present invention, the mineral acid (MA) is an inorganic acid having a pKs (MA)<3.3, preferably pKs (MA)<0. In particular, the mineral acid is a proton donator. In particular, an iron salt, e.g. FeCl₃, or aluminium salt, e.g. AlCl₃, are not mineral acids. For example, FeCl₃ is a flocculation agent which forms Fe₂O₃ and in combination with water it forms the ion [Fe(H₂O)₆]³⁺.

The iron oxide binds the microplastic and flocculate together with the microplastic. In contrast to that, the acid of the present invention, in particular the organic acid and mineral acid, or a product thereof does not flocculate in its respective acidic form together with the micropastic. Therefore, the aggregated micropastic or agglomerated microplastic is free of an acid of the present invention or products thereof. “Free of” means in this context a content which allows the solution in which the acid is present not to have an pH<pKs of the microplastic.

In embodiments of the first aspect of the present invention, the liquid sample is waste water comprising diagnostic assay reagents after use, in particular diagnostic assay reagents produced by turbimetric based assays and/or electrochemiluminescence based assays.

In embodiments of the first aspect of the present invention, the liquid sample is a potassium hydroxide containing alkaline solution, which comprises at least one surfactant. The surfactant can be selected from the following group: polydocanol, Tween, Poloxamer, Trition.

In embodiments of the first aspect of the present invention, the surfactant is nonaethylene glycol monododecyl ether (Polidocanol).

A surfactant, as used in the context of the instant invention, is a compound that is amphipathic, i.e., containing both hydrophobic groups and hydrophilic groups. Preferably surfactants are chosen which are capable of binding to the surface of the microplastic thereby preferably stabilizing the microplastic surfactants with a variety of chain lengths, hydrophilic-lipophilic balance (HLB) values and surfaces charges can be employed depending upon the application. Preferably, the surfactant according to the invention is a quateranary ammonium salt, alkylbenzenesulfonates, lignin sulfonates, polyoxylethoxylate, or sulfate ester. Non-limiting examples of surfactants are cetyltrimethylammonium bromide, cetyltrimethylammonium chloride, nonyphenolpolyethoxylates (i.e. NP-4, NP-40 and NP-7), sodium dodecylbenzenesulfonate, ammonium lauryl sulfate, sodium laureth sulfate, sodium myreth sulfate, docusate, perfluorooctanesulfonate, perfluorobutanesulfonate, al-kyl-aryl ether phosphates, alkyl ether phosphates, sodium stearate, 2-acrylamido-2-methylpropane sulfonic acid, ammonium perfluorononanoate, magnesium laureth sulfate, perfluorononanoic acid, perfluorooctanoic acid, phospholipids, potassium lauryl sulfate, sodium alkyl sulfate, sodium dodecyl sulfate, sodium laurate, sodium lauroyl sarcosinate, sodium nonanoyloxybenzenesulfonate, sodium pareth sulfate, behentrimonium chloride, benzalkonium chloride, benzethonium chloride, bronidox, dim ethyl dioctadecylammonium bromide, dim ethyl dioctadecylammonium chloride, lauryl methyl gluceth-10 hydroxypropyl dimonium chloride, octenidine dihydrochloride, olaflur, N-oleyl-1,3-propane diamine, stearalkonium chloride, tetramethylammonium hydroxide, thonzonium bromide, cetomacrogol 1000, cetostearyl alcohol, cetyl alcohol, cocamide DEA, cocamide MEA, decyl polyglu-cose, disodium cocoamphodiacetate, glycerol monostearate, polyethylene glycol isocetyl ether, octylphenoxypolyethoxyethanol, lauryl glucoside, maltosides, monolaurin, mycosub-tilin, nonoxynols, octaethylene glycol monododecyl ether, N-octyl beta-D-thioglucopyranoside, octyl glucoside, oleyl alcohol, pentaethylene glycol monododecyl ether, polidocanol, poloxamer, polyethoxylated tallow amine, polyglycerol polyricinoleate, polysorbate, sorbitan, sorbitan monolaurate, sorbitan monostearate, sorbitan tristearate, stearyl alcohol, surfactin, Triton X-100, Tween 80, cocamidopropyl betaine, cocamidopro-pyl hydroxysultaine, dipalmitoylphosphatidylcholine, hydroxysultaine, 1Lauryldimethyla-mine oxide, lecithin, myristamine oxide, peptitergents, sodium lauroamphoacetate and bis(2-ethylhexyl)sulfosuccinic ester.

The following particles consists of polystyrene based material with avarage particle sizes between 100 nm and 20 0 nm, in particular 110-140 nm. The particles are surface modified to exhibt a negative charge at solution pH-values of 7. Further the surface is modified with a respective polypeptide, moreover an antibody. The storage solutions are different buffers e.g. gylcin, Pluronic P85 or 2-(N-Morpholino)ethanesulfonic acid (MES).

The beads can be explained due to their surface loaded polypeptide:
1) MAK<CRP>M-21F12-IgG
2) CRPLX MVR in MES buffer
3) CRPLX MVR in Pluronic P85 solution
4) CRPLX MVR glycine solution

In embodiments of the first aspect of the present invention, the microplastic is a solid phase. Suitable solid phases include but are not limited to Solid Phase Extraction (SPE) cartridges, and beads.

In embodiments of the first aspect of the present invention, the microplastic is a bead or beads. Beads may be non-magnetic, magnetic, paramagnetic or supermagnetic. Beads may be coated differently to be specific for the analyte of interest. The coating may differ depending on the use intended, i.e. on the intended capture molecule. It is well-known to the skilled person which coating is suitable for which analyte. The beads may be made of various different materials. The beads may have various sizes and comprise a surface with or without pores.

In embodiments of the first aspect of the present invention, the bead is non-magnetic.

In embodiments of the first aspect of the present invention, the bead or beads have a particle size in the range of 0.1 μm to 0.3 μm or 50 nm to 500 nm, as determined according to ISO 13320. More preferably, the particle size is in the range of from 0.15 to 0.25 micrometers, more preferably in the range of from 0.18 to 0.22 micrometers.

Methods to provide beads are known to the skilled person and are e.g. described in Lu, Salabas, Schüth, Angew. Chem Int. Ed. 2007, 46, 1222-1244, the respective contents of which are hereby incorporated by reference.

In embodiments of the first aspect of the present invention, the bead comprises a polymer matrix (P) and at least one magnetic or non-magnetic core (M). Preferably, the at least one magnetic core (M) comprises a compound selected from the group consisting of metal, metal carbide, metal nitride, metal sulfide, metal phosphide, metal oxide, metal chelate and a mixture of two or more thereof. The at least one magnetic core (M) may also comprise an alloy with a metal such as gold, silver, platinum or copper.

It is to be understood that each magnetic core (M) may comprise a mixture of two or more of the above-mentioned group, i.e. two or more of a metal, metal carbide, metal nitride, metal sulfide, metal phosphide, metal oxide, a metal chelate and a mixture of two or more thereof. Further, mixtures of two or more different metals, two or more different metal oxides, two or more different metal carbides, two or more different metal nitrides, two or more different metal sulphides, two or more different metal phosphides, two or more dif-ferent metal chelates are conceivable.

Preferably, the particle comprises the polymer matrix (P) in an amount in the range of from 40 to 98% by weight, more preferably in the range of from 50 to 95% by weight, more preferably in the range of from 60 to 90% by weight, and most preferably in the range of from 70 to 85% by weight, based on the total weight of the particle.

The polymer matrix (P) preferably comprises a co-polymer obtained or obtainable by a method comprising a polymerization of at least two different monomeric building blocks selected from the group consisting of styrene, functionalized styrenes, vinylbenzylchloride, divinylbenzene, vinylacetate, methylmethaacrylate and acrylic acid. Preferably, the co-polymer obtained or obtainable by a method comprising a polymerization of at least two different monomeric building blocks selected from the group consisting of the following monomers:

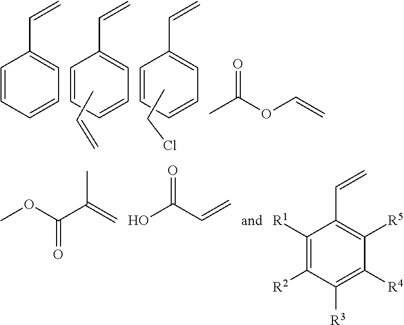

with R¹, R², R³, R⁴ and R⁵, are, independently of each other selected from the group consisting of —N₃, —NH₂, —Br, —I, —F, —NR′R″, —NR′R″R′″, —COOH, —CN, —OH, —OR′, —COOR′, —NO2, —SH2, —SO2, —R′(OH)x, —R′(COOH)x, —R′(COOR″)x, —R′(OR″)x, —R′(NH2)x, —R′(NHR″)x, —R′(NR″R′″)x, —R′ (Cl)x, —R′(I)x, —R′(Br)x, —R′(F)x, R′(CN)x, —R′(N3)x, —R′(NO2)x, —R′(SH2)x, —R′(SO2)x, alkyl, aryl, cycloalkyl, heteroaryl, heterocycloalkyl and with R′, R″ and R′″ being, independently of each other, selected from the group consisting of alkyl, aryl, cycloalkyl, heteroaryl, heterocycloalkyl, halides, hydrogen, sulfides, nitrates and amines, and wherein x is an integer in the range of from 1 to 3.

In principle any polymer known to those skilled in the art may be employed. Preferably, the polymer matrix comprises a crosslinked polymer, this polymer more preferably being obtained or obtainable by a method comprising co-polymerizing suitable monomeric building blocks in the presence of at least one monomeric building block which is a crosslinking agent, thus an agent with which in the resulting polymer a crosslinking is achieved. Suitable agents for crosslinking polymers are known to those skilled in the art, and include, but are not limited to building block such as divinylbenzene, bis(vinylphenyl)ethane, bis(vinylbenzyloxy)hexane, bis(vinylbenzyloxy)dodecane and derivatives of those.

More preferably, the polymer matrix P comprises a crosslinked co-polymer obtained or obtainable by a method comprising the polymerization of at least two different monomeric building blocks as described above, whereby preferably a crosslinked polymer is obtained, wherein the crosslinked polymer is further hypercrosslinked. Thus, more preferably, the polymer matrix comprises, in particular consists of a hypercrosslinked polymer. More preferably, the polymer matrix P is polystyrene latex.

In embodiments of the first aspect of the present invention, the microplastic can be surface modified and/or coated and/or functionalized. The surface of the particle, thus the surface of the polymer matrix (P) is preferably functionalized with at least one group selected from the group consisting of —OH, —COOH, diethylaminoethanol, R—SO₂—OH, —NH₂, R—SO₂—OH, —RNH, —R₂N, —R₃N⁺—CH₃, —C₂H₅, —C₄H₉, —C₈H₁₇, —C₁₈H₃₇, —C₆H₅, —C₆H₉NO₆, Phenyl-Hexyl, Bi-Phenyl, Hydroxyapatit, boronic acid, biotin, azide, epoxide, alkyl, aryl, cycloalkyl, heteroaryl, heterocycloalkyl, aminoacids, —COOR, —COR, —OR, antibodies and fragments thereof, aptameres, nucleic acids, and receptor proteins or binding domains thereof. Preferably, these groups are being covalently attached to suitable functional groups of the polymer matrix. Ways to carry out such modifications are known to those skilled in the art.

In embodiments of the first aspect of the present invention, the microplastic is coated by an antibody or an antigen-binding fragment thereof, wherein the antibody or the antigen-binding fragment thereof is linked to the microplastic covalently or non-covalently.

In embodiments of the first aspect of the present invention, the microplastic and the antibody or the microplastic and the antigen-binding fragment of the antibody are linked via a binding pair, for example, avidin and/or streptavidin as a first partner and biotin or biotin analogues as a second partner.

In embodiments of the first aspect of the present invention, the microplastic and the antibody or the microplastic and the antigen-binding fragment of the antibody are linked via N-hydroxysuccinimide (NETS).

In embodiments of the first aspect of the present invention, the microplastic and the antibody or the microplastic and the antigen-binding fragment of the antibody are linked via click reagents.

In embodiments of the first aspect of the present invention, the microplastic and the antibody or the microplastic and the antigen-binding fragment of the antibody are linked via digitoxin.

In embodiments of the first aspect of the present invention, the microplastic is a surface-modified bead, in particular an antibody-modified bead.

In embodiments of the first aspect of the present invention, the microplastic is negatively charged, in particular negatively charged latex particles. In particular, the acid exhibits a destabilizing effect of negatively charged, protein loaded latex particles.

In embodiments of the first aspect of the present invention, the microplastic is carboxylate-modified polystyrene.

In embodiments of the first aspect of the present invention, the microplastic is streptavidin-coated polystyrene and/or magnetite.

In embodiments of the first aspect of the present invention, the microplastic is magnetic or paramagnetic or supramagnetic or non magnetic. In particular, the microplastic is supramagnetic. The terms “supramagnetic” and “supermagnetic” can be used interchangeably.

In embodiments of the first aspect of the present invention, the microplastic forms particles, which have a particle size in the range of 0.03 μm to 25 μm, in particular in the range of 0.1 μm to 5 μm.

In embodiments of the first aspect of the present invention, the microplastic has a pKs value of 5 or less than 5, e.g. 4.

In embodiments of the first aspect of the present invention, the acid is added until saturation to the liquid sample in step (b). In particular, the acid is added until the pH value of the liquid sample is under the pKs of the microplastic, e.g. below 4 or 5.

In embodiments of the first aspect of the present invention, the liquid sample has a pH<4 in or after step (b).

In embodiments of the first aspect of the present invention, the microplastic is removed in step (d) via a method, which is selected from the group consisting of gravitation, filtration, extraction, separation and combinations thereof. Preferably the microplastic can be extracted by octanol.

In embodiments of the first aspect of the present invention, the liquid sample comprises microplastic in a concentration equal to or greater than 0.01% w/w.

In embodiments of the first aspect of the present invention, the mineral acid is hydrochloric acid (HCl) or sulfuric acid (H₂SO₄) or nitric acid (HNO₃).

In embodiments of the first aspect of the present invention, the acid, in particular mineral acid, is not or does not comprise FeCl₃ and/or AlCl₃.

In embodiments of the first aspect of the present invention, the acid, in particular mineral acid, is not or does not comprise Fe₂O₃ and/or Al₂O₃.

In embodiments of the first aspect of the present invention, the acid is acetic acid.

In embodiments of the first aspect of the present invention, the acid is propanoic acid.

In embodiments of the first aspect of the present invention, the acid is CH₃—[CH₂—CH—COOH]ₘ—CH₃ with m>1. In particular, m is 2 or 3 or 4 or 5 or 6 or 7 or 8 or 9 or 10.

In embodiments of the first aspect of the present invention, the acid is CH₃—[CH₂—CH—COOH]ₚ—[CH—COOH—CH—COOH]_{q}—CH₃ with p>1 and q>1. In particular, p is 2 or 3 or 4 or 5 or 6 or 7 or 8 or 9 or 10. Additionally or alternatively to p, q is 2 or 3 or 4 or 5 or 6 or 7 or 8 or 9 or 10.

In embodiments of the first aspect of the present invention, the acid is HO—SO₂—NH₂(CH)ᵣ(CH₂)ₛ—CH₃ with r>1 and s>1. In particular, r is 2 or 3 or 4 or 5 or 6 or 7 or 8 or 9 or 10. Additionally or alternatively to r, s is 2 or 3 or 4 or 5 or 6 or 7 or 8 or 9 or 10.

In embodiments of the first aspect of the present invention, the acid is mercaptosuccinic acid or succinic acid.

In embodiments of the first aspect of the present invention, the acid is oxalic acid.

In embodiments of the first aspect of the present invention, the acid is salicylic acid or maleic acid.

In embodiments of the first aspect of the present invention, the acid is trifluoroacetic acid.

In embodiments of the first aspect of the present invention, the acid is poly-acrylic acid.

In embodiments of the first aspect of the present invention, the acid is poly(acrylic acid-co-maleic acid).

In embodiments of the first aspect of the present invention, the acid is amidosulfonic acid or p-toluenesulfonic acid.

In embodiments of the first aspect of the present invention, the liquid sample comprise an absorber for improving the separation of the microplastic from the liquid sample. The absorber can be any hydrophobic material which is separated from the surrounding aqueous regime and is therefore not affected within the pH range between 1-14. Examples are: paraffinic wax or n-octanol.

In embodiments of the first aspect of the present invention, the acid is a mixture of at least two acids mentioned above.

Very short chain organic acids or di-acids like acetic acid, malonic acid (1×CH2 adjusted to the acid moiety) as well as alpha-hydroxyl acids like malic, or citric acids are not capable to destabilize the negatively charged nanoparticles.

In embodiments of the first aspect of the present invention, very long chain fatty (allylic chain >7) acids which are insoluble in water cannot act as an acid, e.g. as an destabilizing agents, e.g. stearic acid.

In embodiments of the first aspect of the present invention, amino acids which can also be described as zwitterionic substances and therefore act as a buffer system do not have the ability to destabilize the negatively charged nano-particles due to the fact that amino acids even in saturated solution cannot act as acidic enough to drop the pH value lower than the pKs of the microplastic.

In fact, amino acids can have an effect on the precipitation of negatively charged particles if they are mixed with acids even those which have no effect alone e.g. formic acid in low concentrations and acetic acid.

If after precipitation of the organic nanoparticles which have been destabilized by the respective organic substance additional aqeuos base can be added the effect of precipitation can be reversed. The beads can form rapidly again a non-filterable solution.

In a second aspect, the present invention relates to use of the method according to the first aspect of the present invention for separating at leats one diagnostic assay reagent after use, in particular microplastic, from a liquid sample, in particular from waste water. All embodiments mentioned for the first aspect of the invention apply for the second aspect of the invention and vice versa.

In embodiments of the second aspect of the present invention, the method according to the first aspect of the present invention is used for separating microplastic from a liquid sample, wherein the liquid sample is waste water. In particular the waste water results from a process of turbimetric based assays.

In embodiments of the second aspect of the present invention, the turbimetric based assay is a particle-enhanced turbidimetric immunoassay (PETIA). PETIA is known for a skilled person and therefore is not here described in detail.

In a third aspect, the present invention relates to a tablet for treating a liquid sample comprising at least one diagnostic assay reagent after use, wherein the tablet comprises at least an acid, which is capable of reducing the pH value of the liquid sample below the at least one pKs value of the microplastic, wherein the acid is a powdery solid acid,

wherein the acid is an organic acid or a mineral acid,
wherein the organic acid is selected from the group consisting of

CH₃−[CH₂]ₙ—COH with 1<n<4,

COOH—CH₂—(SH)—CH₂—(CH₃)—COOH,

COOH—COOH,

COOH—C(CH)═C(CH)—OH(COOH),

COOH—CF3,

CH₃—[CH₂—CH—COOH]ₘ—CH₃ with m>1,

CH₃—[CH₂—CH—COOH]ₚ—[CH—COOH—CH—COOH]_{q}—CH₃ with p>1 and q>1 and

HO—SO₂—NH₂(CH)ᵣ(CH₂)ₛ—CH₃ with r>1 and s>1.

All embodiments mentioned for the first aspect of the invention and/or second aspect of the invention apply for the third aspect of the invention and vice versa.

In a fourth aspect, the present invention relates a purified liquid sample obtainable by the method according to the first aspect of the present invention, wherein the liquid sample is waste water, which is cleaned from at least one diagnostic assay reagent after use, wherein in particular the diagnostic assay reagent after use is microplastic. All embodiments mentioned for the first aspect of the invention and/or second aspect of the invention and/or third aspect of the invention apply for the fourth aspect of the invention and vice versa.

In a fifth aspect, the present invention relates to a diagnostic assay reagent obtainable by the method according to the first aspect of the present invention, wherein the diagnostic assay reagent is microplastic, which is agglomerated. All embodiments mentioned for the first aspect of the invention and/or second aspect of the invention and/or third aspect of the invention and/or fourth aspect of the invention apply for the fifth aspect of the invention and vice versa.

In a sixth aspect, the present invention relates to a waste water treatment system for treating a liquid sample comprising at least one diagnostic assay reagent after use, wherein the said system comprises
a vessel, which is capable of collecting the liquid sample having a pH value, wherein at least one diagnostic assay reagent is microplastic having at least one pKs value,
at least one acid, which is capable of adapting the pH value of the liquid sample below the at least one pKs value of the microplastic,
optionally a supporting acid, which is capable of adapting the pH value of the liquid sample below the at least one pKs value of the microplastic,
   wherein the acid is an organic acid or a mineral acid,
   wherein the organic acid is selected from the group consisting of

CH₃−[CH₂]ₙ—COH with 1<n<4,

COOH—CH₂—(SH)—CH₂—(CH₃)—COOH,

COOH—COOH,

COOH—C(CH)═C(CH)—OH(COOH),

COOH—CF3,

CH₃—[CH₂—CH—COOH]ₘ—CH₃ with m>1,

CH₃—[CH₂—CH—COOH]ₚ—[CH—COOH—CH—COOH]_{q}—CH₃ with p>1 and q>1 and

HO—SO₂—NH₂(CH)ᵣ(CH₂)ₛ—CH₃ with r>1 and s>1. All embodiments mentioned for the first aspect of the invention and/or second aspect of the invention and/or third aspect of the invention and/or fourth aspect of the invention and/or fifth aspect of the present invention apply for the sixth aspect of the invention and vice versa.

In embodiments of the sixth aspect of the present invention, the vessel is capable to collect a continous or discontinous liquid stream from a clinical analyzer. The volume of the vessel relates to the volume stream. It needs to be at least the size for which the microparicles takes to destabilize and form the respective agglomereates. The vessel material need to be resistant to pH-values in the range of 1 to 14.

In a seventh aspect, the present invention relates to use of the waste water treatment system of the sixth aspect of the present invention for treating a liquid sample comprising at least one diagnostic assay reagent after use. All embodiments mentioned for the first aspect of the invention and/or second aspect of the invention and/or third aspect of the invention and/or fourth aspect of the invention and/or fifth aspect of the present invention and/or sixth aspect of the invention apply for the seventh aspect of the invention and vice versa.

In a eight aspect, the present invention relates to a kit suitable to perform a method of the first aspect of the present invention comprising
a tablet according to the third aspect of the present invention,
a separation unit, which is capable of separating the microplastic and the liquid sample, and
optionally a vessel. All embodiments mentioned for the first aspect of the invention and/or second aspect of the invention and/or third aspect of the invention and/or fourth aspect of the invention and/or fifth aspect of the present invention and/or sixth aspect of the invention and/or seventh aspect of the invention apply for the eight aspect of the invention and vice versa.

In embodiments of the eight aspect of the present invention, the kit comprises a vessel.

In embodiments of the eight aspect of the present invention, the separation unit is installed after the collection vessel with a continous or discontinues operational behaviour. The separation unit is capable to remove the agglomerated micoparticles by their chemical physical properties e.g. size (e.g. filtration via paper and/or sand etc.) or density (e.g. centrifugation, gravity separateon etc.).

In a ninth aspect, the present invention relates to use of a kit of the eight aspect of the present invention in a method of the first aspect of the present invention. All embodiments mentioned for the first aspect of the invention and/or second aspect of the invention and/or third aspect of the invention and/or fourth aspect of the invention and/or fifth aspect of the present invention and/or sixth aspect of the invention and/or seventh aspect of the invention and/or eigth aspect of the invention apply for the ninth aspect of the invention and vice versa.

In a tenth aspect, the present invention relates to an acid for treating a liquid sample comprising at least one diagnostic assay reagent after use,

wherein said acid is an organic acid or a mineral acid,
wherein the organic acid is selected from the group consisting of

CH₃−[CH₂]ₙ—COH with 1<n<4,

COOH—CH₂—(SH)—CH₂—(CH₃)—COOH,

COOH—COOH,

COOH—C(CH)═C(CH)—OH(COOH),

COOH—CF3,

CH₃—[CH₂—CH—COOH]ₘ—CH₃ with m>1,

CH₃—[CH₂—CH—COOH]ₚ—[CH—COOH—CH—COOH]_{q}—CH₃ with p>1 and q>1 and

HO—SO₂—NH₂(CH)ᵣ(CH₂)ₛ—CH₃ with r>1 and s>1, wherein the acid is capable of changing the pH value of the liquid sample over the pKs value of the at least one diagnostic assay reagent after use.

All embodiments mentioned for the first aspect of the invention and/or second aspect of the invention and/or third aspect of the invention and/or fourth aspect of the invention and/or fifth aspect of the present invention and/or sixth aspect of the invention and/or seventh aspect of the invention and/or eigth aspect of the invention and/or ninth aspect of the invention apply for the tenth aspect of the invention and vice versa.

In further embodiments, the present invention relates to the following aspects:
1. A method for treating a liquid sample comprising at least one diagnostic assay reagent after use, said method comprises
   a) Providing the liquid sample having a pH value, wherein the at least one diagnostic assay reagent is microplastic having at least one pKs value,
   b) Treating the liquid sample comprising at least an acid so that the pH value of the liquid sample is smaller than the at least one pKs value of the microplastic, wherein, in particular the changing of the pH value of the liquid sample is induced by the acid itself or a supporting acid,
   wherein the acid is an organic acid or a mineral acid,
   wherein the organic acid is selected from the group consisting of

CH₃−[CH₂]ₙ—COH with 1<n<4,

COOH—CH₂—(SH)—CH₂—(CH₃)—COOH,

COOH—COOH,

COOH—C(CH)═C(CH)—OH(COOH),

COOH—CF3,

CH₃—[CH₂—CH—COOH]ₘ—CH₃ with m>1,

CH₃—[CH₂—CH—COOH]ₚ—[CH—COOH—CH—COOH]_{q}—CH₃ with p>1 and q>1 and

HO—SO₂—NH₂(CH)ᵣ(CH₂)ₛ—CH₃ with r>1 and s>1.
2. The method according to aspect 1, wherein the liquid sample has a pH value of 7 or more than 7 in step a).
3. The method of any of the proceeding aspects, wherein the pH value of the liquid sample is alkaline, for example, more than 11.
4. The method of any of the proceeding aspects, comprising at least one further step selected from the group consisting of:
   c) Agglomeration the microplastic in the liquid sample,
   d) Removing the microplatic, in particular the agglomerated microplastic, from the liquid sample,
   e) Increasing the pH value of the liquid sample after removing the microplastic, for example, to a pH value of 7 or more,
   and combinations of steps (c) to (e).
5. The method of any of the proceeding aspects, wherein the microplastic agglomerates in step (c) if the pH value of the liquid sample is smaller than the at least one pKs value of the microplastic.
6. The method of any of the proceeding aspects, wherein the mineral acid (MA) is an inorganic acid having a pKs (MA)<0.
7. The method of any of the proceeding aspects, wherein the liquid sample is waste water comprising at least one diagnostic assay reagent after use, in particular a diagnostic assay reagent produced by turbimetric based assays and/or electrochemiluminescence based assays.
8. The method of any of the proceeding aspects, wherein the liquid sample is a potassium hydroxide containing alkaline solution, which comprises at least one surfactant.
9. The method of aspect 8, wherein the surfactant is nonaethylene glycol monododecyl ether (Polidocanol).
10. The method of any of the proceeding aspects, wherein the microplastic is a solid phase.
11. The method of any of the proceeding aspects, wherein the microplastic is a bead.
12. The method of any of the proceeding aspects, wherein the microplastic is coated by an antibody or an antigen-binding fragment thereof, wherein the antibody or the antigen-binding fragment thereof is linked to the microplastic covalently or non-covalently.
13. The method of aspect 12, wherein the microplastic and the antibody or the microplastic and the antigen-binding fragment of the antibody are linked via a binding pair, for example, avidin and/or streptavidin as a first partner and biotin or biotin analogues as a second partner.
14. The method of aspect 12, wherein the microplastic and the antibody or the microplastic and the antigen-binding fragment of the antibody are linked via N-hydroxysuccinimide (NETS).
15. The method of aspect 12, wherein the microplastic and the antibody or the microplastic and the antigen-binding fragment of the antibody are linked via click reagents.
16. The method of aspect 12, wherein the microplastic and the antibody or the microplastic and the antigen-binding fragment of the antibody are linked via digitoxin.
17. The method of any of the proceeding aspects, wherein the microplastic is a surface-modified bead, in particular an antibody-modified bead.
18. The method of any of the proceeding aspects, wherein the microplastic is negatively charged, in particular negatively charged latex particles.
19. The method of any of the proceeding aspects, wherein the microplastic is carboxylate-modified polystyrene.
20. The method of any of the proceeding aspects, wherein the microplastic is streptavidin-coated polystyrene and/or magnetite.
21. The method of any of the proceeding aspects, wherein the microplastic is magnetic or paramagnetic or supramagnetic or non-magnetic.
22. The method of any of the proceeding aspects, wherein the microplastic forms particles, which have a particle size in the range of 0.03 μm to 25 μm, in particular in the range of 0.1 μm to 5 μm.
23. The method of any of the proceeding aspects, wherein the microplastic has a pKs value of 5 or less than 5, e.g. 4.
24. The method of any of the proceeding aspects, wherein the acid is added until saturation to the liquid sample in step (b).
25. The method of any of the proceeding aspects, wherein the liquid sample has a pH<4 in or after step (b).
26. The method of any of the proceeding aspects, wherein the microplastic is removed in step (d) via a method, which is selected from the group consisting of gravitation, filtration, extraction, separation and combinations thereof
27. The method of any of the proceeding aspects, wherein the liquid sample comprises microplastic in a concentration equal to or greater than 0.01% w/w.
28. The method of any of the proceeding aspects, wherein the mineral acid is hydrochloric acid (HCl) or sulfuric acid (H₂SO₄) or nitric acid (HNO₃).
29. The method of any of the proceeding aspects, wherein the acid, in particular mineral acid, is not or does not comprise FeCl₃ and/or AlCl₃.
30. The method of any of the proceeding aspects, wherein the acid is propanoic acid.
31. The method of any of the proceeding aspects, wherein the acid is mercaptosuccinic acid or succinic acid.
32. The method of any of the proceeding aspects, wherein the acid is oxalic acid.
33. The method of any of the proceeding aspects, wherein the acid is salicylic acid or maleic acid.
34. The method of any of the proceeding aspects, wherein the acid is trifluoroacetic acid.
35. The method of any of the proceeding aspects, wherein the acid is poly-acrylic acid.
36. The method of any of the proceeding aspects, wherein the acid is poly(acrylic acid-co-maleic acid).
37. The method of any of the proceeding aspects, wherein the acid is amidosulfonic acid or p-toluenesulfonic acid.
38. Use of the method according to any of aspects 1 to 37 for separating at least one diagnostic assay reagent after use, in particular microplastic, from a liquid sample, in particular from waste water.
39. A tablet for treating a liquid sample comprising at least one diagnostic assay reagent after use, wherein the tablet comprises
   at least an acid, which is capable of reducing the pH value of the liquid sample below the at least one pKs value of the microplastic, wherein the acid is a powdery solid acid,
   wherein the acid is an organic acid or a mineral acid,
   wherein the organic acid is selected from the group consisting of

CH₃−[CH₂]ₙ—COH with 1<n<4,

COOH—CH₂—(SH)—CH₂—(CH₃)—COOH,

COOH—COOH,

COOH—C(CH)═C(CH)—OH(COOH),

COOH—CF3,

CH₃—[CH₂—CH—COOH]ₘ—CH₃ with m>1,

CH₃—[CH₂—CH—COOH]ₚ—[CH—COOH—CH—COOH]_{q}—CH₃ with p>1 and q>1 and

HO—SO₂—NH₂(CH)ᵣ(CH₂)ₛ—CH₃ with r>1 and s>1.
40. A purified liquid sample obtainable by the method according to any of the aspects 1 to 37, wherein the liquid sample is waste water, which is cleaned from at least one diagnostic assay reagent after use, wherein in particular the diagnostic assay reagent after use is microplastic.
41. A diagnostic assay reagent obtainable by the method according to any of the aspects 1 to 37, wherein the diagnostic assay reagent is microplastic, which is agglomerated.
42. A waste water treatment system for treating a liquid sample comprising at least one diagnostic assay reagent after use, wherein the said system comprises
   a vessel, which is capable of collecting the liquid sample having a pH value, wherein at least one diagnostic assay reagent is microplastic having at least one pKs value,
   at least one acid, which is capable of adapting the pH value of the liquid sample below the pKs value of the microplastic,
   optionally a supporting acid, which is capable of adapting the pH value of the liquid sample below the at least one pKs value of the microplastic,
   wherein the acid is an organic acid or a mineral acid,
   wherein the organic acid is selected from the group consisting of

CH₃−[CH₂]ₙ—COH with 1<n<4,

COOH—CH₂—(SH)—CH₂—(CH₃)—COOH,

COOH—COOH,

COOH—C(CH)═C(CH)—OH(COOH),

COOH—CF3,

CH₃—[CH₂—CH—COOH]ₘ—CH₃ with m>1,

CH₃—[CH₂—CH—COOH]ₚ—[CH—COOH—CH—COOH]_{q}—CH₃ with p>1 and q>1 and

HO—SO₂—NH₂(CH)ᵣ(CH₂)ₛ—CH₃ with r>1 and s>1.
43. Use of a waste water treatment system of aspect 42 for treating a liquid sample comprising at least one diagnostic assay reagent after use.
44. A kit suitable to perform a method of any one of aspects 1 to 37 comprising
   a tablet according to aspect 34,
   a separation unit, which is capable of separating the microplastic and the liquid sample, and
   optionally a vessel.
45. Use of a kit of aspect 44 in a method of any one of aspects 1 to 37.
46. An acid for treating a liquid sample comprising at least one diagnostic assay reagent after use, wherein said acid is an organic acid or a mineral acid, wherein the organic acid is selected from the group consisting of

CH₃−[CH₂]ₙ—COH with 1<n<4,

COOH—CH₂—(SH)—CH₂—(CH₃)—COOH,

COOH—COOH,

COOH—C(CH)═C(CH)—OH(COOH),

COOH—CF3,

CH₃—[CH₂—CH—COOH]ₘ—CH₃ with m>1,

CH₃—[CH₂—CH—COOH]ₚ—[CH—COOH—CH—COOH]_{q}—CH₃ with p>1 and q>1 and
HO—SO₂—NH₂(CH)ᵣ(CH₂)ₛ—CH₃ with r>1 and s>1, wherein the acid is capable of changing the pH value of the liquid sample over the pKs value of the at least one diagnostic assay reagent after use.

### Examples

The following examples are provided to illustrate, but not to limit the presently claimed invention.

Experimental Design for Organic Acid Test:

The test can be done by the following steps:

1) A liquid sample was prepared: Reference latex beads with fluorescence marker (0.4% m/v) solution, as microplastic was mixed 1:20 with (CellWash®, purchased from Roche Diagnostics) solution and vortexed. The pH of the liquid sample was pH>11, with a final microplastic level (bead concentration) of 0.02% (m/v) in 10 ml total volume. The blue stain of the microplastic, in particular latex beads, enabled a very good visual clue for the presence or absence of microplastic in the supernatant. The microplastic has at least one pKs value, e.g. 1 or 2 or 3.

Reference latex beads as used herein were carboxymethyl latex particles (200 nm diameter), dyed with JG9 (5-6 μmol/g latex), conjugated with the polymeric form of anti-digoxigenin Ab MAK<Dig>M-19-11-IgG (200 mg Ab/g latex) via sNHS/EDC and glycin stop storage buffer: 5 mM KP pH 7.4, 1% RPLA new, 0.01% MIT, 0.25% CAA dilution/working buffer: TAPS 62.5 mM pH 8.5/NaCl 1.25 M/Tween 20 0.06%/RPLA4 0.3 5%/NaN3 0.0009%/12 0.5 μg/ml MAK<CK-MM>M33-IgG, 12.5 μg/ml MAK<CK-MM>M33-IgG1/Fab′l-Poly working concentration: 0.1% washing buffer 10 mM Tris/HCl pH 8.0, 0.1% Triton X-100, 0.01% Oxipyrion, 0.001% MIT. Reference latex beads are disclosed in EP2631007A1, wherein the disclosure content is hereby incorporated by reference.

The latex reagent or latex beads can be composed of polystyrene particles, in particular 110-140 nm or 221 nm. Antibodies used for detection can be covalently bound to the surface. The beads can be carboxylate modified. The covalent binding of antibodies to the bead surface might be establisched using a sulfo-NHS/EDC chemistry. The antibody can be specific for each assay and can for example be anti-CRP. In a different embodiment, antibodies can be substituted with antigen, however, the particles can be similar to the previously described ones. Particles can furthermore be fluorescently labled, in particular, JG9 can be used.

CM—carboxylate modified, Lx—latex, JG9—dye, MAK-antibody, Dig—Digmarked=linker M-19-11-IgG—second antibody

2) To the liquid sample described in (1), a selected acid was added until the respective solution was saturated. The pH value of the liquid sample is smaller than the at least one pKs value of the microplastic.

3) The liquid sample of (2) was relaxed for approximately 5 min and afterwards filtrated through a Whatmann paper filter supported by a funnel.

4) The pH of the filtered liquid sample of (3) was measured and visually inspected for microplastic (blue fluorescent beads). The results were evaluated using the following three criteria:

(0) no bead precipitation, no filtration residue found;

(1) slow bead precipitation with incompleate filtration result;

(2) fast bead precipitation, but incomplete filtration;

(3) fast bead precipitation with a high filter yield of close to 100%. Slow means in this case, 5 min to 60 min. Fast means in this case, <5 min.

The results are shown in the following table 1.

Experimental Design for Amino Acid Test:

The test can be done by the following steps:

1) A liquid sample was prepared: Reference Beads Latex with fluorescence marker (0.4% m/v) solution, see experiment above as microplastc was mixed 1:20 with NaOH (CleanWash, purchased from Roche Diagnostics) solution and vortexed. The pH of the liquid sample was pH>11, with a final microplastic level (bead concentration) of 0.02% (m/v) in 10 ml total volume. The blue stain of the microplastic, in particular latex beads, enabled a very good visual clue for the presence or absence of microplastic in the supernatant. The microplastic has at least one pKs value.

2) To the liquid sample described in (1), a selected amino acid was added until the liquid sample was saturated.

3) The liquid sample of (2) was relaxed for approximately 5 min afterwards filtrated through a Whatmann paper filter supported by a funnel.

4) The pH of the filtered liquid sample of (3) was measured and visually inspected for microplastic (blue fluorescent beads).

The results were evaluated using the following three criteria

(0) no bead precipitation, no filtration residue found;

(1) slow bead precipitation with incompleate filtration result;

(2) fast bead precipitation, but incomplete filtration;

(3) fast bead precipitation with a high filter yield of close to 100%

5) If no residue on the filter paper was visual the filtrate was splitted and spiked with formic acid or acetic acid to drop the pH of the resulting solution to approximately pH=3 and followed the steps 3) and 4)

The results are shown in the following table 1.

Experimental Design for Microplastic Size (Bead Size) and Protein Loading Test:

The test can be done by the following steps:

1) The respective microplastic (beads, see table 2) are mixed 1:20 with NaOH (CleanWash, purchased from Roche Diagnostics) solution and vortexed. The pH of the respective liquid sample was pH>11, with a final microplastic level (bead concentration) of 1/20 of the original solution (see table 2) (m/v) in 10 ml total volume.

2) To the liquid sample described in (1), a maleic acid was added until the respective solution exhibits a pH<3

3) The liquid sample of (2) was relaxed for approximately 5 min and afterwards filtrated through a Whatmann paper filter supported by a funnel.

4) The pH of the filtered liquid sample of (3) was measured and visually inspected for microplastic (blue fluorescent beads). The results were evaluated using the following three criteria:

(0) no bead precipitation, no filtration residue found;

(1) slow bead precipitation with incomplete filtration result;

(2) fast bead precipitation, but incomplete filtration;

(3) fast bead precipitation with a high filter yield of close to 100%

Experimental Design Bead Aggregate Recovery Test:

Precipitated microplastic, e.g. beads from the experimental design for organic acid test have been used after filtration step and covered with 5 ml Clean Wash solution (Cell Wash Solution 1/NaOH-D 04880285, purchased from Roche Diagnostics) onto the precipitated beads on the filter.

TABLE 1
Details on the organic and mineral acids:

| | | pH in a | |
|---|---|---|---|
| | | saturated | |
| | | aqueous | |
| Tested acid | Structure | solution | Effect |
| 1,8-napthalic acid anhydrid | 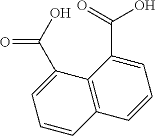 [SMILES: O=C(O)c1cccc2cccc(C(=O)O)c12] | 12.4 | 0 |
| BENZOIC ANHYDRID | 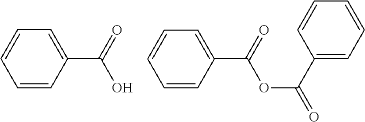 | 12.3 | 0 |
| Glutaric Acid anhydrid | 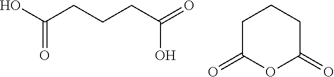 [SMILES: O=C(O)CCCC(=O)O ; O=C1CCCC(=O)O1] | 4.3 | 2 |
| terepthalic acid | 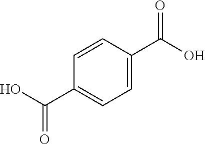 [SMILES: O=C(O)c1ccc(C(=O)O)cc1] | 5.9 | 0 |
| mercaptosuccinic acid | 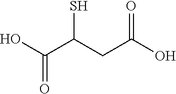 | 3.5 | 3 |
| DL-MALIC ACID | 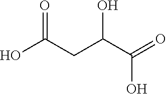 | 2.9 | 0 |
| TEREPHTHALIC ACID MONOMETHYLESTER | 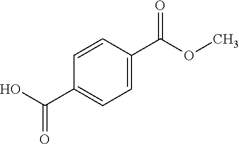 | 12.2 | 0 |
| DICHLORMAL ACID ANHYDRIDE | 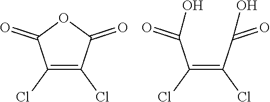 | 2 | 2 |
| Tartaric acid | 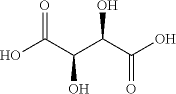 | 2.5 | 0 |
| Maleic acid | 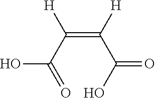 | 1 | 3 |
| Citric acid | 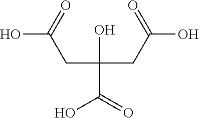 [SMILES: O=C(O)CC(O)(CC(=O)O)C(=O)O] | 2.5 | 0 |
| MALONIC ACID | 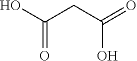 | 1.7 | 0 |
| Stearic acid | 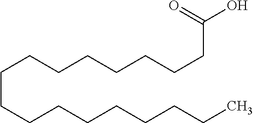 [SMILES: CCCCCCCCCCCCCCCCCC(=O)O] | 12.3 | 0 |
| Bernstensäure (Succinic acid) | 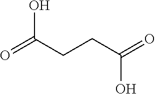 | 4.3 | 0 |
| glutaric Acid | 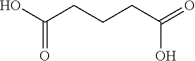 | 4 | 1 |
| Amidosulfonic acid | 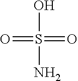 | 0.7 | 2 |
| polyacrylic acid | 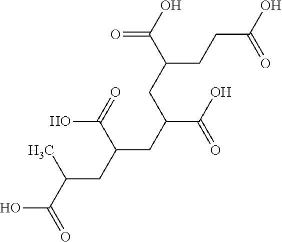 [SMILES: CC(CC(CC(CC(CCC(=O)O)C(=O)O)C(=O)O)C(=O)O)C(=O)O] | 4.2 | 2 |
| Salicydic acid | 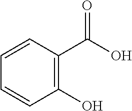 | 4.3 | 3 |
| oxalic acid | 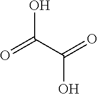 | 0.9 | 1 |
| PMMA-co-MA | 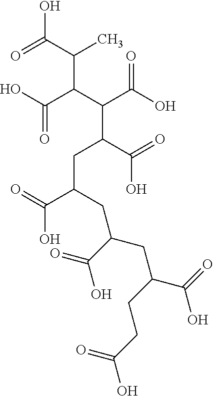 [SMILES: CC(C(=O)O)C(C(=O)O)C(C(=O)O)C(CC(CC(CC(CCC(=O)O)C(=O)O)C(=O)O)C(=O)O)C(=O)O] | 4.1 | 2 |
| Ameisensäure | 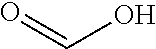 | 2.1 | 0 |
| Essigsäure | 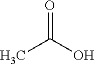 | 3.8 | 0 |
| Propionsäure | 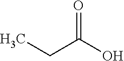 | 4.3 | 3 |
| Trifluroacetic acid | 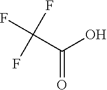 | 0.2 | 3 |
| para- Toulosulfonic acid | 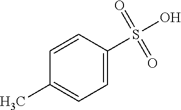 | 0.5 | 2 |
| Strong mineralic acid e.g. HCL konz | | <1 | 3 |
| Descalling tablet from | | 1.5 | 3 |
| Jura | | | |

Effect as shown in table 1: The results were evaluated using the following the criteria (0), (1), (2) and (3). Ameisensaure=formic acid, Essigsaure=acetic acid, Propionsaure=propionic acid.

As it can seen from the results of table 1, the following acids are capable of precipitate the microplastic in the liquid sample: glutaric anhydride, mercaptosuccinic acid, dichloromaleic anhydride, maleic acid, succinic acid, glutaric acid, amidosulfonic acid, polyacrylic acid, salicylic acid, oxalic acid, poly(methyl methacrylate-co-methacrylic acid) (PMMA-co-MA), proponic acid, trifluoroacetic acid, p-toluenesulfonic acid, mineral acids, in particular strong inorganic acids. Additionally, decalcification tablets, e.g. decalcification tablets from the company Jura shows a fast bead precipitation with a high filter yield of close to 100%. Decalcification tablets can comprises maleic acid, sulfamidic acid, sodium bicarbonate and benzotriaole according to regulation (EG) Nr. 648/2004. The bicarbonate is responsible for the good dissolving properties of the tablet and the benzotriazole is responsible for keeping the metal pipes intact.

Preferably, the microplastic, e.g. microplastic particles, is negatively charged and comprises a surface protein, e.g. antibody. Therefore, the microplastic is destabilized in a good manner.

For formic acid a concentration dependency has been found. If c=0.2 M formic acid have been used the effect was 0. Higher concentrations of formic acid of c>0.5 M (pH<2) lead to a further concentration depended effect up to 2.

Amino acids have been found in their natural form to be not active due to the fact that the pH drop of an alkaline solution is not sufficient to reach a pH value<pKs of the nano-beads. The addition of acids like acetic acid or formic acid which drops the pH<pKs of the beads resulted for all amino acids in a precipitation of the nano-beads with effect 2 to 3.

The effect of destabilization and precipitation after acid addition can be vanished by increasing the pH value of the precipitate by e.g. a basic solution e.g. using CleanCell reagent. The aggregated or agglomerated microplastic beads are forming a smaller particles which go through normal paper filter material.

Different nanoparticle sizes and protein loadings of the microplastic are investigated:

The following additional microplastics, in particular beads have been screend without protein loading:

TABLE 2

| | | | Carboxy | Color | Precipitation | | Polypeptide |
|---|---|---|---|---|---|---|---|
| Product | | | Modified | n.z.-not | with maleic | Latex | Surface |
| Number | Diameter | | (yes/no) | applicable | acid (yes/no) | Paricle | Modification |
| 43302- | 0.1 | μm | no | n.z. | no | yes | no |
| 5ML-F | | | | | | | |
| 89904- | 1 | μm | no | n.z. | no | yes | no |
| 5ML-F | | | | | | | |
| 72986- | 10 | μm | no | n.z. | no | yes | no |
| 5ML-F | | | | | | | |
| 90768- | 150 | μm | no | n.z. | no | yes | no |
| 5ML | | | | | | | |
| L5155- | 0.03 | μm | yes | yellow- | no | yes | no |
| 1ML | | | | green | | | |
| L3280- | 0.5 | μm | yes | red | no | yes | no |
| 1ML | | | | | | | |
| L3030- | 2 | μm | yes | red | yes (also | yes | no |

| | |
|---|---|
| 1ML | blank |
| | precipitated) |
| | no effect |
| | from maleic |
| | acid |
| | observable |

The microplastic with the above mentioned product number are purchased from Sigma-Aldrich and/or ThermoFisher.

Microplastic with the product numbers 89904-5ML-F, 43302-5ML-F, 72986-5ML-F and 90768-5ML are micro particles based on polystyrene, in particular latex beads from PS. Microplastic with the product number L5155-1ML is latex beads, carboxylate-modified polystyrene, fluorescent yellow-green. Microplastic with the product numbers L3280-1ML and L3030-1ML are latex beads, carboxylate-modified polystyrene, fluorescent red. The microplastics with the different product numers differ in their particle size diameter as mentioned in column 2 of table 2.

The following additional microplastics, in particular beads have been screened with protein loading:

TABLE 3

| | | Carboxy | Precipitation | Polypeptide |
|---|---|---|---|---|
| | | Modified | with maleic acid | Surface |
| Description of the beads | Diameter | (yes/no) | (yes/no) | Modification |
| Thermo Opti-Link Core Bead | 0.2 μm | yes | no | no |
| (83000520100390) | | | | |
| Particles that contain | | | | |
| carboxylic acid groups for | | | | |
| covalent coupling and that can | | | | |
| be used in a variety of | | | | |
| applications. | | | | |
| Thermo Opti-Link Core Bead | 0.2 μm | yes | no | no |
| with JG9 dye non covalently | | | | |
| bound | | | | |
| Thermo Opti-Link Core Bead | 0.2 μm | yes | yes | yes |
| with JG9 dye and MAK (CK- | | | | |
| MM) | | | | |
| Thermo Opti-Link Core Bead | 0.2 μm | yes | yes | yes |
| with JG9 dye and MAK (<NT- | | | | |
| proBNP> and MAK 33) | | | | |
| Thermo Opti-Link Core Bead | 0.2 μm | yes | yes | yes |
| with JG9 dye and MAK | | | | |
| (<DIG> and MAK 33) | | | | |
| CRPLX HIT/INT MP1 | 0.11 μm | yes | yes | yes |
| CRPLX HIT/INT MP2 | 0.25 μm | yes | yes | yes |

The microplastic Opti-Link Core particle with the above mentioned product number are purchased from Thermofisher, which can be modified accordingly. Table 3 contains intermediate product steps and also different bead loadings starting from the core bead. A skilled person is capable from the description colum to figure out which surface modification has been done.

Protein coated Thermo Opti-Link Core Beads can be precipitated by an acid, e.g. maleic acid, compared to protein uncoated Thermo Opti-Link Core Beads. In particular, the protein is a monoclonal antibody (MAK).

The observed effects can be explained by a two step process.
1) Any active substance need to bring down a pH value of the liquid sample lower than the at least one pKs value of the microplastic, e.g. beads, with the respective surface protein. This can be done by addition of the acid itself or by addition of a supporting acid e.g. formic acid or acetic acid.
2) A) The active substance need to support the proximity by its respective organic backbone of the destabilized nanoparticles to form larger clusters which can precipitate and or can be filtered.
   B) The active substance need to support a destabilization of any micelle and detergent forming structures by their organic nature. Any detergent can hold nanoparticles by the lipohilic/hydrophilic properties in solution. This is disturbed by the addition of active substances for negatively charged nanoparticles.

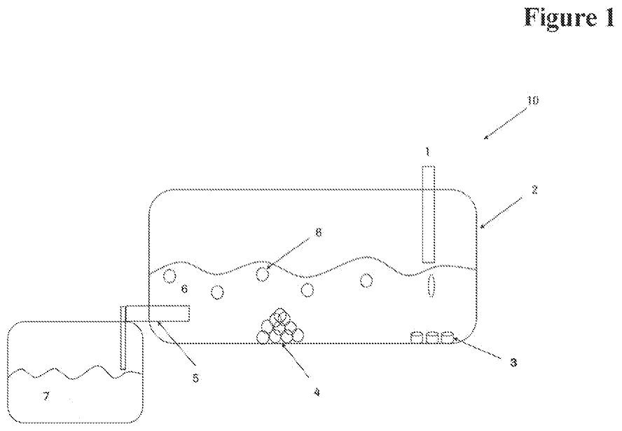

FIG. 1 shows a waste water treatment system 10 for treating a liquid sample 6 comprising at least one diagnostic assay reagent after use 8, in particular microplastic having a particle size of smaller than 500 nm. The waste water treatment system 10 comprises a vessel 2. The vessel 2 collects the liquid sample 6, in particular waste water comprising microplastic having a particle size of smaller than 500 nm. The liquid sample 6 has a pH value. In particular, the liquid sample 6 has a pH value of more than 10 before treating with an acid, e.g. a pH value of 11 or more. In this case the at least one diagnostic assay reagent is microplastic 8. The microplastic 8 has a pKs value of 5 or less than 5. The system 10 can comprise a supporting acid for adapting the pH value of the liquid sample below the at least one pKs value of the microplastic (here not shown).

The liquid sample 6 comprising microplastic 8 is collected in the vessel 2. Additionally, a tablet 3 is added, which comprises at least one acid, which is part of a tablet 3. The tablet can comprise further substances, e.g. additives (here not shown). The acid is capable of adapting the pH value of the liquid sample below the at least one pKs value of the microplastic. The acid is an organic acid or a mineral acid. The organic acid can be selected from the group consisting of CH3-[CH2]n-COOH with 1<n<4, COOH—CH2-(SH)—CH2-(CH3)-COOH, COOH—COOH, COOH—C(CH)═C(CH)—OH(COOH), COOH—CF3, CH3-[CH2-CH—COOH]m-CH3 with m>1, CH3-[CH2-CH—COOH]p-[CH—COOH—CH—COOH]q-CH3 with p>1 and q>1 and HO—SO2-NH2(CH)r(CH2)s-CH3 with r>1 and s>1. The liquid sample 6 is treated with the at least one acid. After treating the liquid sample 6 with at least one acid, the pH value of the liquid sample 6 decrease below the at least one pKs value of the microplastic 8.

Then, the microplastic 8 forms aggregates or agglomerates 4. The aggreagtes or agglomerates 4 can comprise serum. The aggregates or agglomerates 4 of the microplastic 8 can be easily separated e.g. by gravitation, filtration, extraction and/or separation. The aggreagtes or agglomerates 4 can have a particle size of more than 500 nm. The purified liquid sample 7 without microplastic or substantially without microplastic can be recylcled and e.g. transferred in another vessel, e.g. a collection vessel of purified water. The term “substantially without microplastic” can mean in this context that at least 80 percent of the microplastic in the (purified) liquid sample is/was deleted (1—liquid flow, 5—separation unit, e.g. filtration unit).

This patent application claims the priority of the European patent application 20187160.5, wherein the content of this European patent application is hereby incorporated by references.

1. A method for treating a liquid sample comprising at least one diagnostic assay reagent after use, said method comprising
a) Providing the liquid sample having a pH value, wherein the at least one diagnostic assay reagent is microplastic having at least one pKs value,
b) Treating the liquid sample comprising at least one acid so that the pH value of the liquid sample is smaller than the at least one pKs value of the microplastic, wherein the changing of the pH value of the liquid sample is induced by the acid itself or a supporting acid,
wherein the acid is an organic acid or a mineral acid,
wherein the organic acid is selected from the group consisting of
CH₃—[CH₂]ₙ—COOH with 1<n<4,
COOH—CH₂—(SH)—CH₂—(CH₃)—COOH,
COOH—COOH,
COOH—C(CH)═C(CH)—OH(COOH),
COOH—CF3,
CH₃—[CH₂—CH—COOH]ₘ—CH₃ with m>1,
CH₃—[CH₂—CH—COOH]ₚ—[CH—COOH—CH—COOH]_{q}—CH₃ with p>1 and q>1 and
HO—SO₂—NH₂(CH)ᵣ(CH₂)ₛ—CH₃ with r>1 and s>1.

2. The method of claim 1, wherein the liquid sample has a pH value of 7 or more than 7 in step a).

3. The method of claim 1, further comprising at least one further step selected from the group consisting of:
c) Agglomeration of the microplastic in the liquid sample,
d) Removing the microplastic from the liquid sample,
e) Increasing the pH value of the liquid sample after removing the microplastic to a pH value of 7 or more, and
f) Determining the pKs value of the microplastic, wherein if only known types of pKs exhibiting particles through the diagnostic process exist or are present, a predetermined pKs value can be used,
and any combination of steps (c) to (f).

4. The method of claim 1, wherein the liquid sample is waste water comprising the at least one diagnostic assay reagent after use.

5. The method of claim 1, wherein the microplastic is a surface-modified bead.

6. The method of claim 1, wherein the microplastic is negatively charged.

7. The method of claim 1, wherein the at least one diagnostic assay reagent after use is separated from the liquid sample.

8. A tablet for treating a liquid sample comprising at least one diagnostic assay reagent after use, wherein the tablet comprises
at least one acid capable of reducing the pH value of the liquid sample below the at least one pKs value of the microplastic,
wherein the acid is a powdery solid acid,
wherein the acid is an organic acid or a mineral acid,
wherein the organic acid is selected from the group consisting of
CH₃—[CH₂]ₙ—COOH with 1<n<4,
COOH—CH₂—(SH)—CH₂—(CH₃)—COOH,
COOH—COOH,
COOH—C(CH)═C(CH)—OH(COOH),
COOH—CF₃,
CH₃—[CH₂—CH—COOH]ₘ—CH₃ with m>₁,
CH₃—[CH₂—CH—COOH]ₚ—[CH—COOH—CH—COOH]_{q}—CH₃ with p>₁ and q>₁ and
HO—S₀₂—NH₂(CH)ᵣ(CH₂)ₛ—CH₃ with r>₁ and s>₁.

9. A purified liquid sample obtainable by the method of claim 1, wherein the liquid sample is waste water cleaned from the microplastic.

10. A diagnostic assay reagent obtainable by the method of claim 1, wherein the diagnostic assay reagent is agglomerated microplastic.

11. A waste water treatment system for treating a liquid sample comprising at least one diagnostic assay reagent after use, wherein the system comprises
a vessel capable of collecting the liquid sample having a pH value, wherein at least one diagnostic assay reagent is microplastic having at least one pKs value,
at least one acid capable of adapting the pH value of the liquid sample below the at least one pKs value of the microplastic,
optionally a supporting acid capable of adapting the pH value of the liquid sample below the at least one pKs value of the microplastic,
wherein the one acid is an organic acid or a mineral acid,
wherein the organic acid is selected from the group consisting of
CH₃—[CH₂]ₙ—COOH with 1<n<4,
COOH—CH₂—(SH)—CH₂—(CH₃)—COOH,
COOH—COOH,
COOH—C(CH)═C(CH)—OH(COOH),
COOH—CF3,
CH₃—[CH₂—CH—COOH]ₘ—CH₃ with m>1,
CH₃—[CH₂—CH—COOH]ₚ—[CH—COOH—CH—COOH]_{q}—CH₃ with p>1 and q>1 and
HO—SO₂—NH₂(CH)ᵣ(CH₂)ₛ—CH₃ with r>1 and s>1.

12. (canceled)

13. A kit suitable to perform a method of claim 1 comprising
a tablet,
a separation unit capable of separating the microplastic and the liquid sample, and
a vessel.

14. (canceled)

15. An acid for treating a liquid sample comprising at least one diagnostic assay reagent after use,
wherein said acid is an organic acid or a mineral acid,
wherein the organic acid is selected from the group consisting of
CH₃—[CH₂]ₙ—COOH with 1<n<4,
COOH—CH₂—(SH)—CH₂—(CH₃)—COOH,
COOH—COOH,
COOH—C(CH)═C(CH)—OH(COOH),
COOH—CF3,
CH₃—[CH₂—CH—COOH]ₘ—CH₃ with m>1,
CH₃—[CH₂—CH—COOH]ₚ—[CH—COOH—CH—COOH]_{q}—CH₃ with p>1 and q>1 and
HO—SO₂—NH₂(CH)ᵣ(CH₂)ₛ—CH₃ with r>1 and s>1, wherein the acid is capable of changing
the pH value of the liquid sample over the at least one pKs value of the at least one diagnostic assay reagent after use.

16. The method of claim 4, wherein the diagnostic assay reagent is produced by turbimetric based assays and/or electrochemiluminescence based assays.

17. The method of claim 5, wherein the surface-modified bead is an antibody-modified bead.

18. The method of claim 6, wherein the microplastic is negatively charged latex particles.

19. The method of claim 7, wherein the at least one diagnostic assay reagent is microplastic and the liquid sample is waste water.
